(19) United States
(12) Patent Application Publication
(10) Pub. No.: US 2026/0106393 A1
(43) Pub. Date: Apr. 16, 2026

(54) CONNECTOR FOR A CIRCUIT BOARD

(71) Applicant: MD Elektronik GmbH, Waldkraiburg (DE)

(72) Inventors: Thomas Halbig, Dietfurt (DE); Stefan Fuchs, Ampfing (DE); Rudolf Engl, Ampfing (DE)

(21) Appl. No.: 19/336,556

(22) Filed: Sep. 23, 2025

(30) Foreign Application Priority Data
Oct. 10, 2024 (DE) 10 2024 129 238.5

(51) Int. Cl. H01R 12/72; H01R 12/70

(52) U.S. Cl. CPC H01R 12/722; H01R 12/7064

(57) ABSTRACT

A connector for a circuit board includes a housing, at least one signal line having a line end that is connected in a signal-conducting manner to a signal line of a mating connector, at least one positioning element which encloses the line end, a fastening unit which forms a receiving space and is connected to the housing, and a carrier unit which is arranged within the housing and the receiving space. The positioning element is configured to position the line end in a signal-conducting manner relative to the signal line of the mating connector, and the positioning element is arranged within the carrier unit. The carrier unit has a first opening through which the positioning element protrudes out of the carrier unit parallel to a plug-in axis, the positioning element is movable relative to the carrier unit in a direction parallel to the plug-in axis.

### CROSS REFERENCE TO RELATED APPLICATIONS

This application claims benefit to German Patent Application No. DE 10 2024 129 238.5, filed on Oct. 10, 2024, which is hereby incorporated by reference herein

### FIELD

The invention relates to a connector for a circuit board and for optical signal lines.

### BACKGROUND

For the transmission of very large amounts of signals and data, optical signal lines, such as fiber optic cables, have proven themselves in practice for decades. In the course of digitization and automation, optical signal lines are increasingly being used in areas where electrical signal lines have long been predominant, as the required transmission volumes are becoming increasingly difficult to provide with electrical signal lines. However, with the advent of optical signal lines in new areas of application, the requirements profile of signal lines and connector systems with which optical signal lines can be connected is also changing. Accordingly, there is an increasing demand for cost-effective connector systems for optical signal lines that are very robust and resistant to environmental influences, and in particular resistant to mechanical stresses that may act on the plug connection during the mating process or in the mated state.

A further problem with optical connector systems is that the optical signal line in the area of the connector system has to be elaborately protected against contamination or damage in order to ensure the functional reliability of the signal line and/or the connector system. Connector systems for circuit boards, in which the signal of the signal line is transmitted to the circuit board, pose a particular problem hereby, as the optical signal must also be converted into an electrical signal. This generally has a negative effect on the installation space of the connector system.

### SUMMARY

In an embodiment, the present disclosure provides a connector for a circuit board includes a housing, at least one signal line having a line end that is connected in a signal-conducting manner to a signal line of a mating connector, at least one positioning element which encloses the line end, a fastening unit which forms a receiving space and is connected to the housing, and a carrier unit which is arranged within the housing and the receiving space. The positioning element is configured to position the line end in a signal-conducting manner relative to the signal line of the mating connector, and the positioning element is arranged within the carrier unit. The carrier unit has a first opening through which the positioning element protrudes out of the carrier unit parallel to a plug-in axis, the positioning element is movable relative to the carrier unit in a direction parallel to the plug-in axis. The carrier unit has a spring element which biases the positioning element against a plug-in direction, and the carrier unit is mounted by spring-elastic bearing elements within the housing and/or the fastening unit so that the carrier unit is movable radially to the plug-in axis. The bearing elements are configured to hold the carrier unit in an initial position and to apply a force to it which forces the carrier unit back into the initial position when the carrier unit is moved radially relative to the plug-in axis from the initial position.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 shows a perspective exploded view of an embodiment of a connector according to the present disclosure;

FIG. 2 shows a further perspective view of the embodiment of the connector according to the present disclosure;

FIG. 3 shows a view of an embodiment of a carrier unit and a fastening unit for a connector according to the present disclosure;

FIG. 4 shows a view of a further embodiment of the connector according to the present disclosure;

FIG. 5 shows a sectional view of a further embodiment of the connector according to the present disclosure;

FIG. 6 shows a further perspective view of an embodiment of the connector according to the present disclosure; and

FIG. 7 shows a perspective view of a further embodiment of the connector according to the present disclosure.

### DETAILED DESCRIPTION

Embodiments of the present disclosure provide a connector for a circuit board that overcomes disadvantages of the prior art and, in particular, ensures high mechanical load capacity with low installation space.

A connector for a circuit board according to an embodiment of the present disclosure has a housing, at least one signal line, a positioning element, a fastening unit, and a carrier unit. The signal line has a line end that can be connected in a signal-conducting manner to a signal line of a mating connector. Preferably, the signal line can be connected in a signal-conducting manner at a front face of the line end to a front face of a signal line of the mating connector. The positioning element surrounds the line end. The fastening unit forms a receiving space. Furthermore, the fastening unit is connected to the housing. The carrier unit is arranged inside the housing and inside the receiving space. The receiving space may be arranged inside the housing. Thus, the part of the carrier unit that is arranged inside the receiving space is also arranged inside the housing. The positioning element is configured to position the line end in a signal-conducting manner relative to the signal line of the mating connector and, in particular, to hold it in position. The positioning element is arranged at least in sections within the carrier unit. The carrier unit has a first opening through which the positioning element protrudes from the carrier unit parallel to a plug-in axis. Preferably, a main direction of extension of the first opening is therefore arranged parallel to the plug-in axis.

In this context, a plug-in axis may be understood as an imaginary axis of movement along which the connector and the mating connector are moved in order to be connected or disconnected from each other. The positioning element is movable relative to the carrier unit parallel to the plug-in axis. Preferably, the positioning element projects to varying extents from the carrier unit depending on the respective movement position. The carrier unit has a spring element which biases the positioning element against a plug-in direction. In this context, a plug-in direction may be understood as a direction in which the mating connector has to be moved relative to the connector along the plug-in axis in order to be able to connect the mating connector to the connector. The carrier unit is mounted within the housing and/or the fastening unit by means of Stelluspring-elastic bearing elements in such a manner that the carrier unit is movable radially with respect to the plug-in axis. Preferably, the carrier unit is movable along any radial direction extending from the plug-in axis. The bearing elements are configured to hold the carrier unit in an initial position. In this context, an initial position may be understood as a position or state which the carrier unit supported by the bearing elements has when no external forces are acting on the carrier unit. The bearing elements can hold the carrier unit in the initial position, with the bearing elements being arranged in a tension-free manner between the carrier unit and the fastening unit and/or the housing. In an embodiment of the present disclosure, the carrier unit can also be held in the initial position by the bearing elements applying a force to the carrier unit. Furthermore, the bearing elements are configured to apply a force to the carrier unit that forces the carrier unit back into the initial position when the carrier unit is moved radially relative to the plug-in axis from of the initial position.

An embodiment of the present disclosure provides a connector for circuit boards that is particularly suitable for connecting optical signal lines. The movable arrangement of the positioning element in the carrier unit allows for forces acting parallel to the plug-in axis on the positioning element to be balanced, which minimizes the risk of damage. However, due to the biasing of the positioning element against the plug-in direction, it is ensured that a reliable connection with a mating connector is still enabled. The arrangement of the carrier unit in the receiving space also allows simple pre-assembly of the carrier unit on the fastening unit. The carrier unit that is pre-assembled on the fastening unit can then be easily inserted into the housing. By mounting the carrier unit in the housing and/or in the receiving space of the fastening unit, the carrier unit is mounted in a floating manner radially relative to the plug-in axis. This prevents, in particular when connecting the connector according to an embodiment of the present disclosure to a mating connector, transverse forces from acting on the positioning element, which would lead to mechanical stresses that could disconnect the signal-conducting connection between the connector and the mating connector or damage the signal line. Such transverse forces can arise, for example, if the connector is not connected to the mating connector properly parallel to the plug-in axis, but at an angle inclined to the plug-in axis. The floating mounting allows for these transverse forces to be damped at least to such an extent that the signal line and the positioning element are not damaged. By forcing the carrier unit, and thus the positioning element, back into the initial position with a force, the bearing elements ensure that the positioning element always remains correctly positioned even for multiple plugging operations. Preferably, the positioning element is movable within the carrier unit radially to the plug-in axis. In this way, an additional floating mounting of the positioning element within the carrier unit can be provided.

The carrier unit can be mounted within the housing and/or the fastening unit by at least three bearing elements which are arranged around the plug-in axis. In this way, only a few bearing elements are required to ensure that the carrier unit can be moved evenly radially to the plug-in axis and is reliably moved back to its initial position by the bearing elements. Three bearing elements are particularly advantageous if the carrier unit has a cylindrical shape. In this case, the bearing elements are preferably distributed at equal angular intervals around the plug-in axis. If the carrier unit has a cross-sectional shape that differs from a cylindrical shape and is, in particular, mirror-symmetrical, which may be the case, for example if a plurality of positioning elements are arranged within the carrier unit, the carrier unit can be mounted via four or more bearing elements. In this case, the bearing elements can be arranged mirror-symmetrically, wherein the plane of symmetry is arranged preferably parallel to the plug-in axis.

At least some of the bearing elements can be formed by first spring webs that are arranged on the fastening unit. The first spring webs can protrude into the receiving space and bear against the carrier unit. The first spring webs can be formed monolithically with the fastening unit. In this context, it is advantageous if the fastening unit and the first spring webs are made of a thermoplastic material. In this case, the elastic behavior of the plastic can be used to produce the spring action of the bearing elements.

At least some of the bearing elements can be formed by second spring webs which are arranged on the carrier unit and bear against a housing wall and/or an inner wall of the receiving space. The second spring webs can be formed monolithically with the carrier unit. Furthermore, it is preferred that the carrier unit is made of a thermoplastic material. The second spring webs preferably extend away from the carrier unit. In an exemplary embodiment of the present disclosure, the fastening unit exhibits first spring webs which protrude into the receiving space and bear against the carrier unit, wherein the carrier unit has second spring webs which bear against the housing wall.

The carrier unit can be connected to the fastening unit by a latching connection which fastens the carrier unit in an axis of movement parallel to the plug-in axis. Preferably, the carrier unit and the fastening unit are connected to each other within the receiving space via the latching connection. In this way, it can be prevented that the carrier unit is able to move parallel to the plug-in axis and relative to the fastening unit. The carrier unit is detachably connected to the fastening unit by means of the latching unit. Thus, not only assembly but also disassembly of the carrier unit on the fastening unit is possible in a simple manner. The carrier unit may, for example, have latching tabs that engage in latching receptacles in the fastening unit.

The housing can have at least two circuit board fastening elements for fastening the housing to the circuit board. The housing may be connected to the circuit board fastening elements in a detachable or non-detachable manner. The housing may be fastened to the circuit board via the circuit board fastening elements, for example by soldering or pressing.

The fastening unit can be arranged between the circuit board fastening elements and connected to the circuit board fastening elements. This allows the fastening unit to be fastened directly to the circuit board via the circuit board fastening elements. This not only offers the advantage that a separate fastening of the fastening unit within the housing can be dispensed with. In addition, the tolerance chain can also be shortened because the circuit board fastening elements can be connected directly to the circuit board. It is particularly advantageous if the fastening unit is arranged at least in sections within the housing and the fastening unit is connected to the circuit board fastening elements within the housing.

The circuit board fastening elements can be configured as metal sheets that have fastening pins for fastening to a circuit board. If the circuit board fastening elements each have several fastening pins, it is preferable that the fastening pins are connected to each other via the metal sheet. In this way, the degree of complexity of the circuit board fastening elements and thus of the entire housing can be kept low. If the circuit board fastening elements are connected to the fastening unit, the metal sheets may have latching tabs that engage in latching receptacles in the fastening unit. The latching tabs are particularly preferably arranged within the housing in such a way that the fastening unit latches with the latching tabs when inserted, in particular when slid in parallel to the plug-in axis, into the housing.

The fastening unit may have a through-opening through which the signal line is guided into the carrier unit. In this way, the signal line can be led out of the carrier unit and out of the fastening unit. The through-opening preferably extends parallel to the plug-in axis in its direction of extension. It is furthermore preferred that the signal line is led out of the connector according to the invention through the through-opening.

The carrier unit may have at least one stop element with a through channel in which the signal line is guided to the positioning element, which limits the movement path of the positioning element in a plug-in direction. This is a simple way of preventing the positioning element from being pushed too far into the carrier unit and damaged.

The spring element can be clamped between the stop element and the positioning element. For this purpose, the positioning element can have a collar against which the spring element bears. The positioning element is preferably partially enclosed by the spring element.

The stop element may be detachably connected to the carrier unit. This allows for simple assembly and/or disassembly of the positioning element in the carrier unit. Furthermore, this allows, for example, a damaged positioning element or spring element to be replaced, wherein both the carrier unit and the stop element are reusable.

At least two positioning elements can be arranged in the carrier unit, wherein the carrier unit can have at least two first openings, from each of which a positioning element projects from the carrier unit. Preferably, both positioning elements are each biased by a spring element against the plug-in direction, so that the positioning elements are arranged in the carrier unit so as to be movable independently of one another. The carrier unit may have a second opening through which the signal lines are guided to the respective positioning elements. The second opening is preferably located on a side opposite the first openings and preferably extends parallel to the first openings. The second opening can be closed by the stop element, in which case the stop element preferably has two passage channels, with a signal line arranged in each passage channel.

On a rear side of the housing, a guide unit may be arranged which holds the signal line outside the housing in position at least in sections. The guide unit allows for the signal line to be held in a defined position outside the connector according to the invention and fed to the connector. This not only prevents damage to the signal line outside the connector according to an embodiment of the present disclosure, but also facilitates handling of the circuit board after the connector has been fixed to the circuit board. If the carrier unit has several positioning elements and signal lines, it is preferable that the guide unit holds a plurality of signal lines in position. The rear side of the housing can preferably be understood as the side of the housing at which the signal lines are guided into the housing to the carrier unit.

The guide unit can be detachably fastened to the housing. In this way, the connector according to an embodiment of the present disclosure can be provided in a variant with a guide unit and in a variant without a guide unit if the guide unit is not required. Furthermore, this allows for the guide unit to be mounted on the housing before the connector is fastened to the circuit board, which further simplifies the assembly of the connector according to an embodiment of the present disclosure.

Furthermore, further advantages and features of the present disclosure are apparent from the following description of exemplary embodiments. The features described therein and above may be implemented alone or in combination, provided that the features do not contradict each other. The following description of the exemplary embodiments is made with reference to the accompanying drawings.

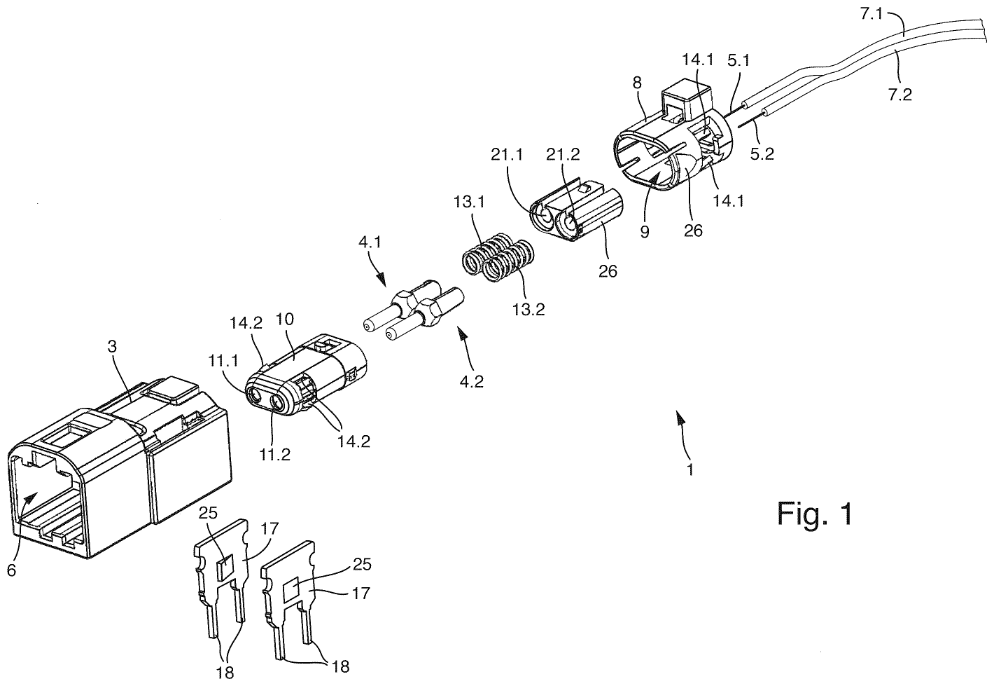

FIG. 1 shows an embodiment of a connector 1 according to the present disclosure for a circuit board in a perspective exploded view. The connector 1 has a housing 3. The housing 3 has two circuit board fastening elements 17, each of which has two fastening pins 18 with which the housing 3 can be fastened to the circuit board. The housing 3 has a plug chamber 6 into which a mating connector can be inserted and connected to the connector 1. The connector 1 further has two positioning elements 4.1; 4.2, which each enclose a line end 5.1, 5.2 of a signal line 7.1; 7.2. In the present embodiment, the signal lines 7.1; 7.2 have optical fibers. In the present embodiment, the signal lines 7.1, 7.2 have a line sheath which each has been removed at the line end 5.1; 5.2. Consequently, the optical fibers are exposed at the line end 5.1; 5.2 and are enclosed in sections by the positioning elements 4.1; 4.2. The signal lines 7.1; 7.2 run through the positioning elements 4.1; 4.2 and each forming a front face 29.1; 29.2 with the positioning elements 4.1; 4.2, on which a positioning element and/or a signal line of a mating connector can be arranged in order to establish a signal-conducting connection.

The positioning elements 4.1; 4.2 are arranged in a carrier unit 10. The carrier unit 10 has two first openings 11.1; 11.2 through which the positioning elements 4.1; 4.2 protrude out of the carrier unit 10 and into the plug chamber 27. The positioning elements 4.1; 4.2 are arranged in sections within the carrier unit 10. The positioning elements 4.1; 4.2 are each arranged within the carrier unit 10 so as to be movable parallel to a plug-in axis. The positioning elements 4.1; 4.2 are each biased by a spring element 13.1; 13.2 against the first openings 11.1; 11.2 and thus against a plug-in direction. In the present embodiment, the spring elements 13.1; 13.2 are configured as coil springs. The spring elements 13.1; 13.2 are in this case supported against a stop element 20, which is also arranged within the carrier unit 10. The stop element 20 is detachably connected to the carrier unit 10. The stop element 20 has two through channels 21.1; 21.2, through each of which a signal line 7.1; 7.2 is guided to the respective positioning element 4.1; 4.2. The stop element 20 delimits the movement path of the positioning elements 4.1; 4.2 in the plug-in direction.

The carrier unit 10, together with the positioning elements 4.1; 4.2, spring elements 13.1; 13.2 and the stop element 20 arranged therein, is arranged in a receiving space 9 of a fastening unit 8. The fastening unit 8 is connected to the housing 3 in that the fastening unit 8 has latching receptacles 26, into which latching elements 25, which are formed by the circuit board fastening elements 17, engage. The fastening unit 8 is thus detachably connected to the housing 3. The carrier unit 10 is mounted within the receiving space 9 on spring-mounted bearing elements 14.1, which are formed by first spring webs 14.1. The first spring webs 14.1 are formed monolithically with the fastening unit 8. The carrier unit 10 itself also has bearing elements 14.2, which are configured as second spring webs 14.2 and are formed monolithically with the carrier unit 10. The carrier unit 10 is mounted within the housing 3 by means of the second spring webs 14.2. By means of the spring-mounted bearing elements 14.1; 14.2 the carrier unit 10 is mounted in a floating manner, in an initial position, within the fastening unit 8, i.e. within the receiving space 9 and within the housing 3 and can be moved radially with respect to the plug-in axis. If the carrier unit 10 is deflected radially relative to the plug-in axis, the bearing elements 14.1; 14.2 exert a force on the carrier unit 10 which forces the carrier unit back into the initial position.

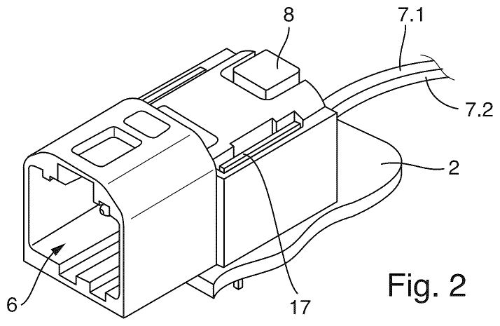

FIG. 2 shows a further perspective view of the embodiment of the connector 1 according to the present disclosure as shown in FIG. 1, wherein the connector 1 is shown in an assembled state. The connector 1 is arranged on a circuit board 2 and is fastened to the latter by means of the circuit board fastening elements 17.

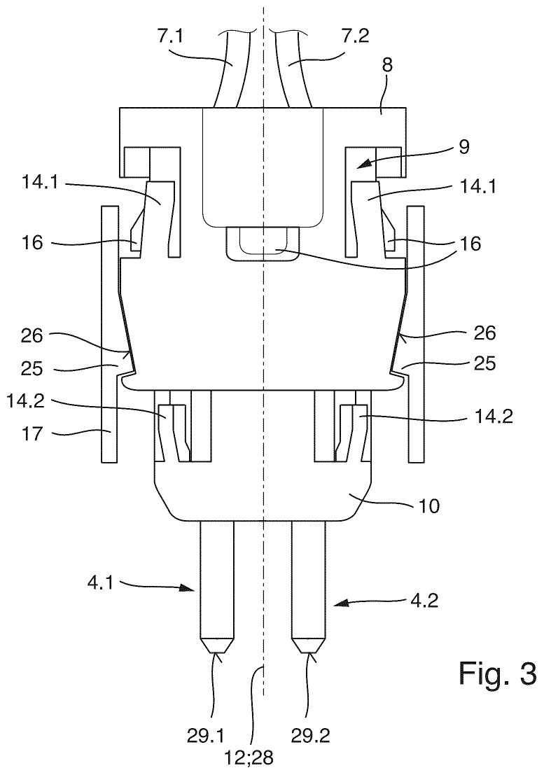

FIG. 3 shows a view of an embodiment of a carrier unit 10 and a fastening unit 8. The plug-in axis 12 hereby runs perpendicular to the direction of view of the viewer. The carrier unit 10 is arranged in the receiving space 9 of the fastening unit 8. The carrier unit 10 is connected to the fastening unit 8 within the receiving space 9 by means of a latching connection 16. The latching connection 16 secures the carrier unit 10 on an axis of movement parallel to the plug-in axis 12. The bearing elements 14.1; 14.2 are arranged in a mirror-symmetrical manner on the carrier unit 10 and on the fastening unit 8, wherein the plane of symmetry 28 is arranged parallel to the plug-in axis 12 and centrally between the positioning elements 4.1; 4.2.

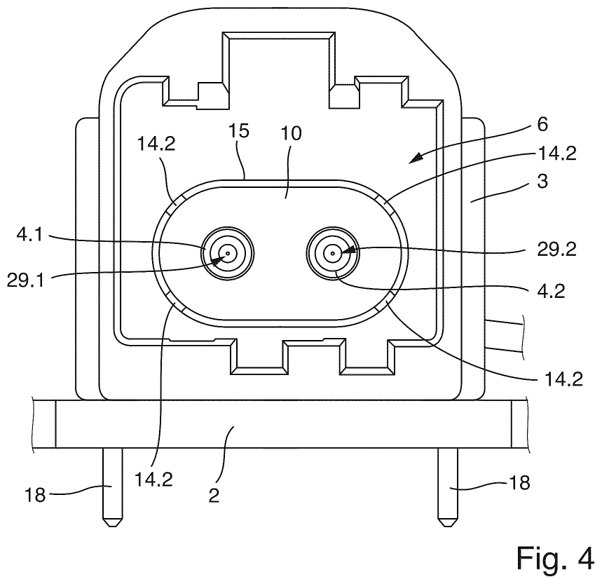

FIG. 4 shows another view of an embodiment of the connector 1 according to the present disclosure, with the plug chamber 17 facing the viewer. The connector 1 is arranged on the circuit board 2, wherein the fastening pins 18 protrude from the underside of the circuit board 2. The fastening pins 18 can thus be soldered to the circuit board, for example. The second spring webs 14.2, which extend away from the carrier unit 10, rest against a housing wall 15 of the housing 3 and thus support the carrier unit 10 within the housing 3.

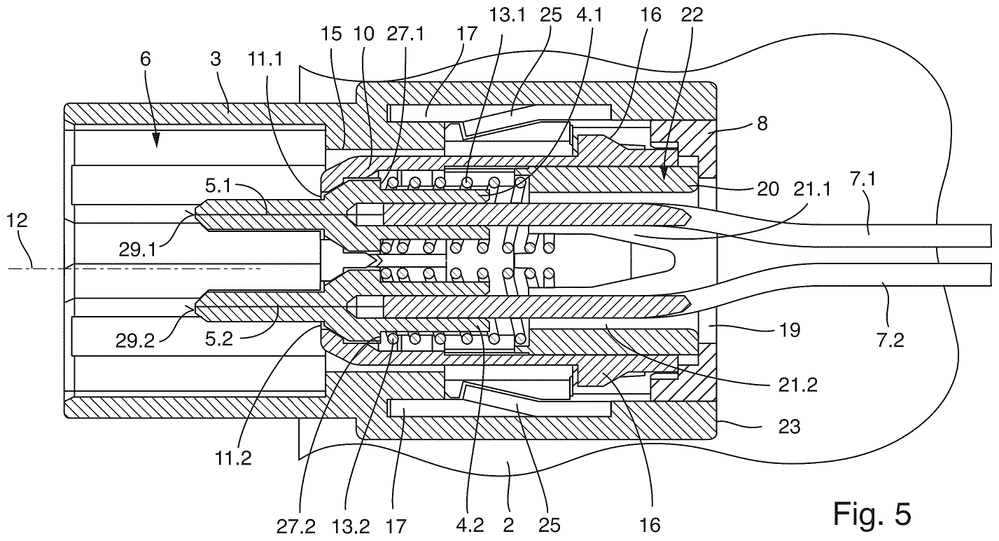

FIG. 5 shows a sectional view of an embodiment of the connector 1 according to the present disclosure, wherein the sectional plane runs parallel to the plug-in axis 12 and through the positioning elements 4.1; 4.2. The fastening unit 8 has a through-opening 19 through which the signal lines 7.1; 7.2 are guided into the through-channels 21.1; 21.2 of the stop element 20 to the positioning elements 4.1; 4.2. The positioning elements 4.1; 4.2 each have a collar 27.1; 27.2 against which the respective spring element 13.1; 13.2 rests. The respective positioning element 4.1; 4.2 is enclosed in sections by the spring elements 13.1; 13.2. Opposite the two second openings 11.1; 11.2, the carrier unit 10 has a second opening 22 which is closed by the stop element 20. The fastening unit 8 is arranged within the housing 3.

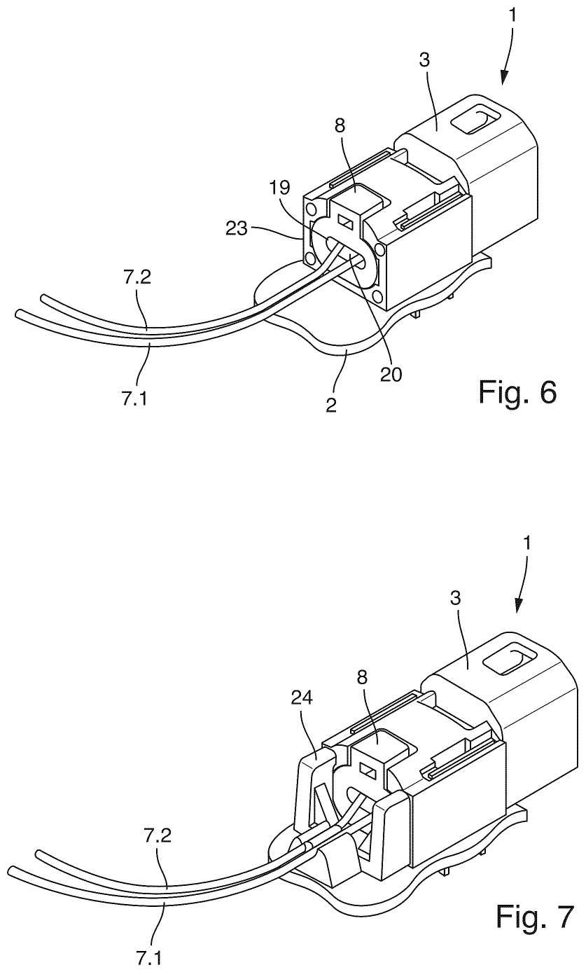

FIG. 6 shows a further perspective view of an embodiment of the connector 1 according to the present disclosure. A rear side 23 of the housing 3 faces the viewer. The signal lines 7.1; 7.2 are inserted into the housing 3 at the rear side 23 via the through-opening 19. The housing 3 is fastened to the circuit board 2.

FIG. 7 shows a further perspective view of an exemplary embodiment of the connector 1 according to the present disclosure, wherein the rear side 23 of the housing faces the viewer. A guide unit 26 is arranged on the rear side 23 of the housing 3 and is detachably connected to the housing 3. In the present embodiment, there is no direct fastening or fixing between the guide unit 26 and the circuit board 2. In other words, the guide unit 26 is fastened to the circuit board 2 via the housing 3. The guide unit 26 holds the signal lines 7.1; 7.2 positioned outside the housing 3 and guides the signal lines 7.1; 7.2 to the housing 3 in a defined manner.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE NUMERALS

1 connector
2 circuit board
3 housing
4 positioning element
5 line end
6 plug chamber
7 signal line
8 fastening unit
9 receiving space
10 carrier unit
11 first opening
12 plug-in axis
13 spring element
14 bearing elements
15 housing wall
16 latching connection
17 circuit board fastening elements
18 fastening pins
19 through-opening
20 stop element
21 through-channel
22 second opening
23 rear side
24 guide unit
25 latching element
26 latching receptacle
27 collar
28 symmetry plane
29 front face

1. A connector for a circuit board, the connector comprising:
a housing;
at least one signal line that has a line end that is connected in a signal-conducting manner to a signal line of a mating connector;
at least one positioning element which surrounds the line end;
a fastening unit which forms a receiving space and is connected to the housing; and
a carrier unit which is arranged within the housing and within the receiving space;
wherein
the positioning element is configured to position the line end in the signal-conducting manner relative to the signal line of the mating connector,
the positioning element is arranged within the carrier unit,
the carrier unit has a first opening through which the positioning element protrudes from the carrier unit parallel to a plug-in axis,
the positioning element is movable parallel to the plug-in axis relative to the carrier unit,
the carrier unit has a spring element which biases the positioning element against a plug-in direction,
the carrier unit is mounted by spring-elastic bearing elements within the housing and/or the fastening unit so that the carrier unit is movable radially to the plug-in axis, and
the spring-elastic bearing elements are configured to hold the carrier unit in a starting position and to apply a force to it which forces the carrier unit back into the starting position when the carrier unit is moved radially relative to the plug-in axis out of the starting position.

2. The connector according to claim 1, wherein the carrier unit is mounted within the housing and/or the fastening unit by at least three bearing elements which are arranged around the plug-in axis.

3. The connector according to claim 1, wherein at least part of the bearing elements are formed by first spring webs which are arranged on the fastening unit, protrude into the receiving space, and bear against the carrier unit.

4. The connector according to claim 3, wherein at least part of the bearing elements are formed by second spring webs which are arranged on the carrier unit and bear against a housing wall and/or an inner wall of the receiving space.

5. The connector according to claim 1, wherein the carrier unit is connected to the fastening unit by a latching connection which secures the carrier unit in an axis of movement parallel to the plug-in axis.

6. The connector according to claim 1, wherein the housing has at least two circuit board fastening elements for fastening the housing to the circuit board.

7. The connector according to claim 6, wherein the fastening unit is arranged between the circuit board fastening elements and is connected to the circuit board fastening elements.

8. The connector according to claim 6, wherein the circuit board fastening elements are configured as metal sheets which have fastening pins for fastening to the circuit board.

9. The connector according to claim 1, wherein the fastening unit has a through-opening through which the signal line is guided into the carrier unit.

10. The connector according to claim 1, wherein the carrier unit has at least one stop element with a through-channel in which the signal line is guided to the positioning element and which delimits a movement path of the positioning element in the plug-in direction.

11. The connector according to claim 10, wherein the spring element is clamped between the stop element and the positioning element.

12. The connector according to claim 10, wherein the stop element is detachably connected to the carrier unit.

13. The connector according to claim 1, wherein at least two positioning elements are arranged in the carrier unit, the carrier unit has at least two first openings, from each of which a positioning element of the at least two positioning elements protrudes from the carrier unit, and the carrier unit has a second opening through which at least two signal lines are guided to the respective positioning element.

14. The connector according to claim 13, wherein a guide unit is arranged on a rear side of the housing, wherein the guide unit holds the signal line of the respective positioning element in a position outside the housing at least in sections.

15. The connector according to claim 14, wherein the guide unit is detachably fastened to the housing.
